(19) United States
(12) Patent Application Publication
(10) Pub. No.: US 2008/0305325 A1
(43) Pub. Date: Dec. 11, 2008

(54) Memory Molding

(76) Inventor: Soung Rea Lee, Seoul (KR)

Correspondence Address: LEVINE & MANDELBAUM, 444 MADISON AVENUE, NEW YORK, NY, 10022, US

(21) Appl. No.: 11/828,798

(22) Filed: Jul. 26, 2007

(30) Foreign Application Priority Data
Jun. 5, 2007 (KR) 2007-54779

(51) Int. Cl. B32B 15/04

(52) U.S. Cl. 428/344

(57) ABSTRACT

A flexible plastic molding for use in building interiors, especially in kitchens and bathrooms around sinks and bathtubs, and between glass window panes and window frames. Embedded within the molding, and extending along its length, is a ductile metal wire which maintains the shape of a bend introduced into the molding along its length, and resists the natural tendency of the plastic molding to spring back to its original condition. The molding may have a flexible central region flanked by two elongated flat surfaces each carrying an adhesive coating. In cross section, the flat surfaces are spaced apart and arranged at an obtuse angle, so that when the molding is installed between two planes at a right angle to each other, the central region of the molding will be compressed and serve to press the flat surfaces against their respective planes.

### BACKGROUND OF THE INVENTION

This invention relates to moldings used to seal, and finish off, joints between two surfaces, such as the lower edge of a toilet and the floor on which it sits, and the edge of a bathtub and a wall on which the bathtub is placed.

Conventionally, joints of the type described above are sealed with a caulking material, such as silicone, dispensed from a tube. This approach tends to be difficult for non-professionals to use because it takes some skill and experience to deposit a continuous bead of the caulking material and to keep the bead even along its length, without making a mess. Moreover, caulk of this type takes time to seal, and in some cases produces a disagreeable odor.

Alternatively, it is known to use plastic moldings, in place of caulk, but this approach also has its disadvantages. One important problem is that the flexible plastic molding, which carries an adhesive coating, is pressed into the joint so that it is bent along its length into a right angle cross-sectional shape. Due to the inherent resilience of the plastic material, the central elongated region of the molding tends to be pulled away from the right angle joint, thereby considerably reducing the strength of the adhesive bond between the molding and surfaces forming the joint being sealed. Over time, this tendency can lead to the molding separating from the joint surfaces.

### BRIEF SUMMARY OF THE INVENTION

It is an object of the present invention to provide a flexible plastic molding which resists any tendency of the molding, after being adhesively installed, from pulling away from the surfaces being sealed.

It is another object of the invention to make the inherently plastic molding ductile so that it retains a bent shape along its length and resists any tendency to spring back to its original shape.

It is a further object of the invention to provide such a molding having two elongated flat surfaces, each bearing an adhesive coating, which in cross section are initially arranged at an obtuse angle so that when the molding is installed between two surfaces at a right angle to each other, the central region of the molding will be compressed and hence serve to press the flat surfaces against their respective planes.

Additional objects and features of the invention will be apparent from the following description, in which reference is made to the accompanying drawings.

### BRIEF DESCRIPTION OF THE DRAWINGS

In the drawings:

FIG. 1 is a schematic view of a toilet having a bead of caulk on its lower edge;

FIG. 2 illustrates a joint sealed by a bead of caulk;

FIG. 3 is a perspective view of a length of molding according to the present invention;

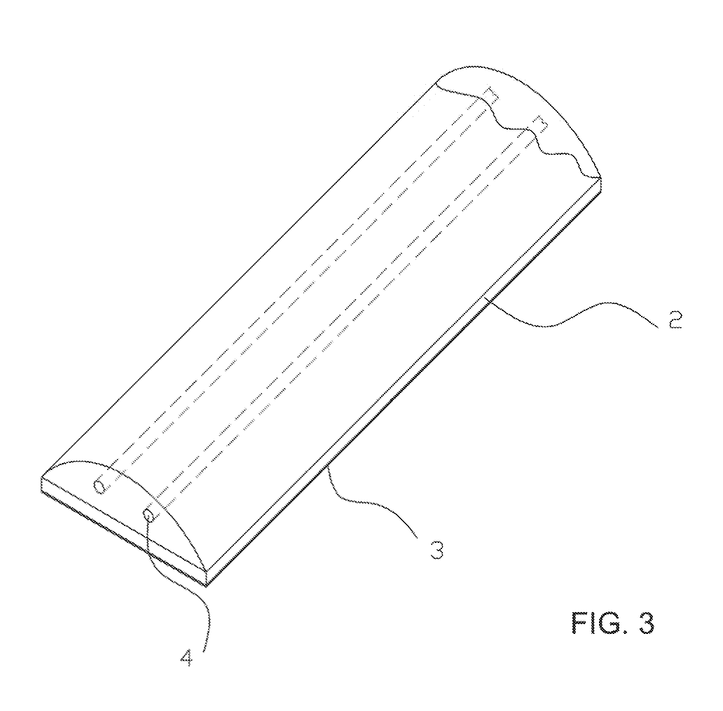

FIG. 4 is a perspective view of another embodiment of a length of molding according to this invention;

FIG. 5 is a cross sectional view through the molding shown in FIG. 3;

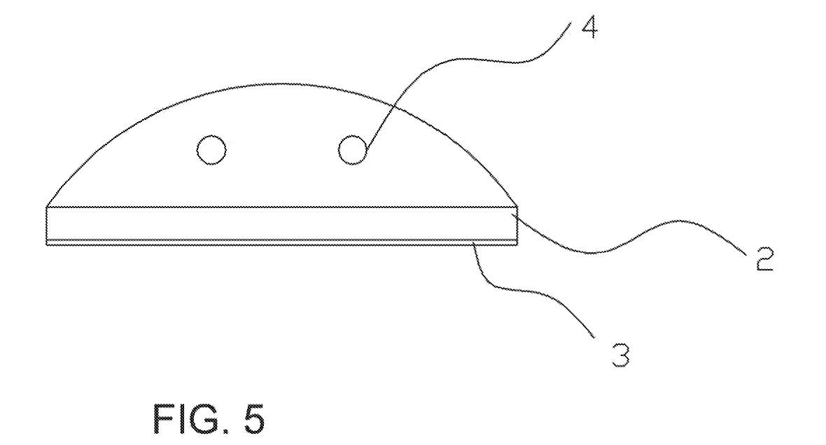

FIG. 6 is a cross sectional view through the molding shown in FIG. 4;

FIG. 7 is a cross sectional view showing the molding of FIGS. 4 and 6 installed between two planes perpendicular to each other; and

FIG. 8 illustrates molding according to the present invention being drawn from a spool upon which a length of the molding is wound.

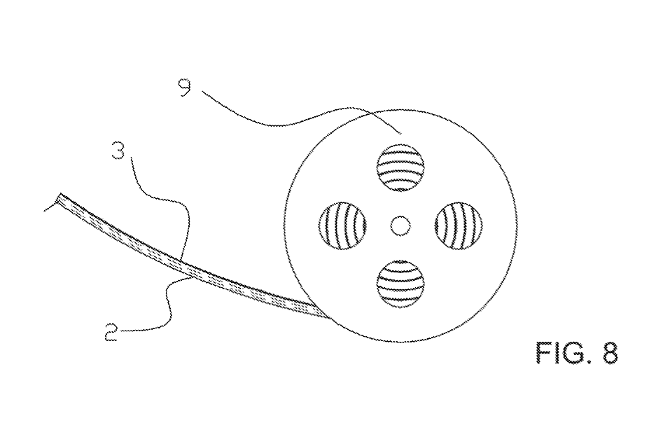

### DETAILED DESCRIPTION OF THE INVENTION

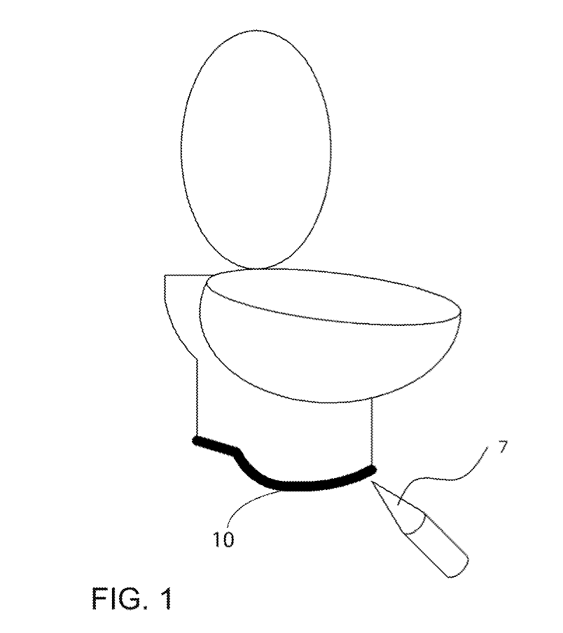

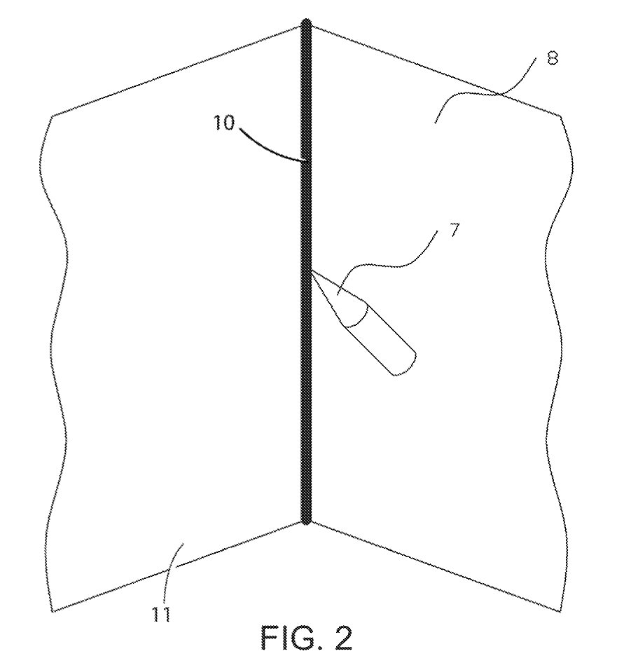

As illustrated in FIG. 1, one conventional way to seal the joint between the bottom edge of a toilet and the floor on which it sits is to squeeze a bead of caulk 10 from a tube 7 of the caulking material. FIG. 2 illustrates a bead of caulk 10 squeezed from a tube 7 into a joint between two planar surfaces, such as a bathtub 11 and a wall 8. In either of the cases illustrated in FIGS. 1 and 2, flexible plastic moldings are available for sealing the joints, in place of the caulk 10.

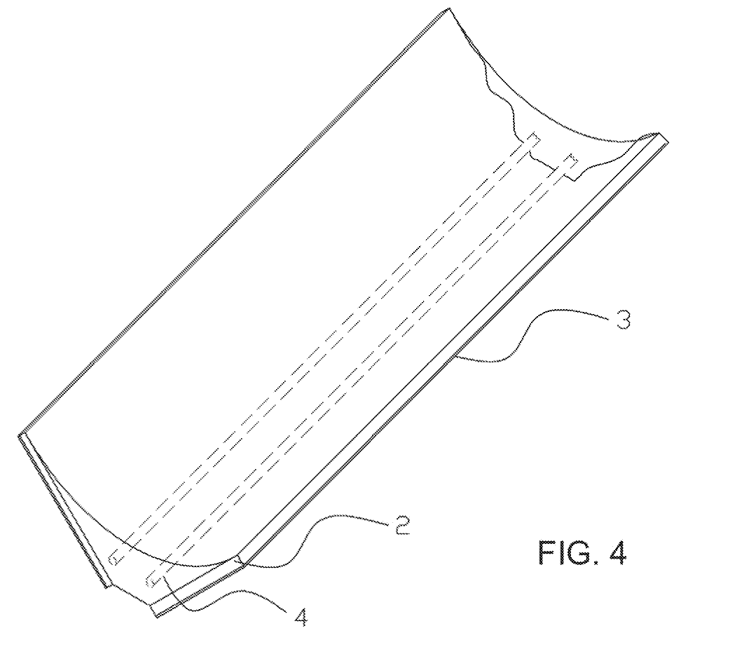

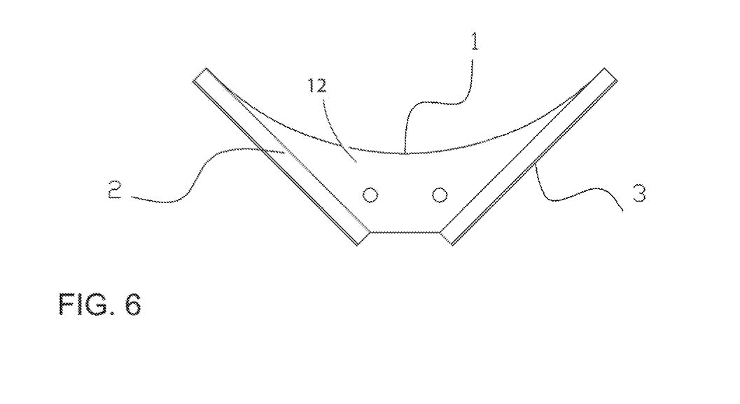

FIGS. 4 and 6 illustrate a molding according to the present invention. The molding 1, preferably fabricated of a flexible plastic material, has a central region 12 presenting two flat surfaces each one of which carries a length of tape 2 bearing an adhesive coating on its outer surface. Initially, the adhesive coating is covered by protective release paper 3. Prior to use of the molding, the release paper 3 is removed, to expose the adhesive coating on tape 2, which is then used to adhesively secure the molding to surfaces which meet to form the joint being sealed.

Embedded within central region 12 of the molding are one or more wires 4, in this case two such wires being shown. The wires are made of a ductile, non-resilient material, such as iron, aluminum, or bronze. If the wire were not present, the inherently flexible molding 1, when bent into a curve, such as is followed by the caulk 10 in FIG. 1, would tend to spring back to its original straight shape. However, due to the presence of wires 4, when the molding is bent into a curved shape, the wires cause the molding to remember that bent shape and prevent the molding from springing back to its original straight shape. Consequently, when a molding of this invention is installed along a curved joint, such as is illustrated in FIG. 1, there is no tendency for the inherent resiliency of the molding material from causing the molding to pull away from the joint to which it is adhered.

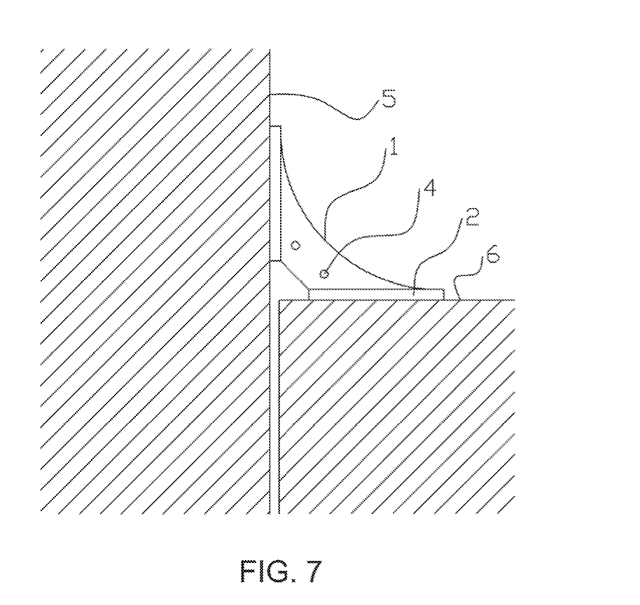

As illustrated most clearly in FIG. 6, the two flat surfaces of molding 1 which carry adhesive tape 2 are arranged at an angle to each other greater than 90°. In addition, the two flat surfaces are spaced from each other. Consequently, when the molding 1 shown in FIGS. 4 and 6 is installed along a joint, shown in FIG. 7, between two planes 5 and 6, arranged at a right angle to each other, and the tapes 2 of the molding are adhesively fixed to the two planes, respectively, central region 12 of molding 1 will be compressed. Due to this compression, the central region tends to press outwardly on the two tapes 2 and helps to maintain firm contact between the adhesive tapes and their respective surfaces.

It will be appreciated, therefore, that as a result of the use of wires 4 extending along the length of the molding, as well as flat surfaces carrying tapes 2, which are initially arranged at an obtuse angle to each other, any tendency of the inherent resiliency of the plastic material of which the molding is formed to cause the molding to separate from the surfaces to which it is adhesively attached is eliminated.

The molding of the present invention is easier to use than conventional moldings and caulks, thereby allowing non-experts to produce neat results when sealing joints. In addition, moldings according to this invention will remain adhesively secured in place longer than conventional moldings, so that they maintain a neat appearance over long periods of time, prevent contamination and mold, are easy to clean, and are ecologically friendly.

1. An elongated flexible plastic molding,
an adhesive coating on a surface of the molding for securing the molding to a surface, and
a ductile metal wire embedded in and extending along the length of the molding for maintaining the shape of a bend introduced into the molding along its length.

2. A molding as defined in claim 1 wherein the metal wire is selected from the group consisting of iron, aluminum, and bronze.

3. A molding as defined in claim 1 having a flexible central region, the central region being between two elongated flat surfaces each carrying an adhesive coating, and the flat surfaces being, as viewed in cross-section, spaced apart and arranged at an obtuse angle to each other, so that when the molding is installed between two planes at a right angle to each other the central region will be compressed and serve to press the flat surfaces against their respective planes.
